(19) United States
(12) Patent Application Publication
(10) Pub. No.: US 2013/0086558 A1
(43) Pub. Date: Apr. 4, 2013

(54) Testing Program Code in Multiple Process Modes

(71) Applicants: Manuel Tellez Merino, Seattle, WA (US); Amith Kamath Kaup, Kirkland, WA (US); Peng Li, Lynnwood, WA (US)

(72) Inventors: Manuel Tellez Merino, Seattle, WA (US); Amith Kamath Kaup, Kirkland, WA (US); Peng Li, Lynnwood, WA (US)

(73) Assignee: MICROSOFT CORPORATION, Redmond, WA (US)

(21) Appl. No.: 13/249,159

(22) Filed: Sep. 29, 2011

(51) Int. Cl. G06F 11/36

(52) U.S. Cl. 717/128; 717/124

(57) ABSTRACT

The subject disclosure is directed towards testing program code in multiple process modes without developing separate test case source code for each process mode. Source code for one or more test cases is developed once in accordance with a standard template. Two or more process mode implementations associated with the one or more test cases are built using common source code. Based on a test command, one or more of the process mode implementations is selected for executing a test plan.

### BACKGROUND

Software development has become a cumbersome endeavor given the number and complexity of different avenues that are currently available for implementing any given software component. There are a number of programming languages which may be used for executing the given software component, such as C, C++, C#, Perl, Python, Javascript™, and VBscript. In addition, there are various platforms and architectures that may be used to execute those instructions. For instance, programs may be intended for Component Object Model (COM), Dynamic Language Runtime (DLR), or native Win32 execution on several architectures, such as x86 systems, 64-bit architectures and/or the like.

Before deploying the software component (e.g., an application, operating system component and/or the like) for customer usage, various types of tests are run to verify compatibility and operability. Unit testing refers to testing a code unit (e.g., a method or class in the program code) immediately after creation or part of a creation process. Unit testing typically involves providing input to a method for which output is known. A result obtained by executing the method is compared against known output values. If they match with each other, then the test passes, or else it fails, which entails corrections in the program code. Unit testing is performed in order to catch errors and bugs in the code at an early stage. In a complex software component, efficient unit testing reduces later efforts to debug the entire software component in more advanced stages. Unit testing improves the overall quality of the software component being created.

Because the program code is developed into different process modes, an appropriate testing mechanism may depend on whether the unit test is specific to a particular process mode, such as a kernel mode or a user mode. For the programmer that is involved with development across a spectrum of languages, architectures or interface standards, creating and running tests to be compatible with different process modes is laborious and redundant.

### SUMMARY

This Summary is provided to introduce a selection of representative concepts in a simplified form that are further described below in the Detailed Description. This Summary is not intended to identify key features or essential features of the claimed subject matter, nor is it intended to be used in any way that would limit the scope of the claimed subject matter.

Briefly, various aspects of the subject matter described herein are directed towards testing program code in multiple process modes without developing separate test case source code for each process mode. In one aspect, when the program code is developed in a kernel mode version and a user mode version, test source code is developed once and built into a user mode implementation and a kernel mode implementation. Hence, developers need not write a user mode version and a kernel mode version of such source code. It is appreciated that the test source code may be associated with one or more test cases (i.e., unit tests). In another aspect, the developers may deploy either implementation at any time during program code testing.

In one aspect, source code that is used to designate a particular test case implementation (e.g., an executable or binary) as user mode or kernel mode is stored as a separate file from the unit test source code. If the user mode test case is to be built, the source code corresponding with the user mode and the unit test source code are compiled together into a user mode implementation, such as a dynamic link library (.DLL). If the kernel mode test case is to be built, the source code corresponding with the kernel mode and the test source code are compiled together into a kernel mode implementation, such as a driver (.SYS).

In another aspect, the source code corresponding with the kernel mode is designed to be common amongst kernel mode implementations of various unit tests. Similarly, the source code corresponding with the user mode is designed to be common amongst user mode implementations of various unit tests. In order to function properly with the common kernel mode source code and/or the common user mode source code, the test source code is structured in accordance with a standard template. Accordingly, compiled versions of the common user mode source code and/or the common kernel mode source code include library functions and/or input/output control codes (IOCTLS), respectively, that call test case functions on compiled test source code.

Other advantages may become apparent from the following detailed description when taken in conjunction with the drawings.

### BRIEF DESCRIPTION OF THE DRAWINGS

The present invention is illustrated by way of example and not limited in the accompanying figures in which like reference numerals indicate similar elements and in which:

FIG. 1 is a block diagram illustrating an exemplary system for testing program code in multiple process modes according to one example implementation.

FIG. 2 is a block diagram illustrating components of an exemplary framework for unit testing program code according to one example implementation.

FIG. 3 is a block diagram illustrating exemplary source code for use in an exemplary framework for unit testing program code according to one example implementation.

FIG. 4 is a flow diagram illustrating exemplary steps for testing program code in multiple process modes according to one example implementation.

FIG. 5 is a flow diagram illustrating exemplary steps for selecting one or more process mode implementations of one or more test cases according to one example implementation.

FIG. 6 is a block diagram representing exemplary non-limiting networked environments in which various embodiments described herein can be implemented.

FIG. 7 is a block diagram representing an exemplary non-limiting computing system or operating environment in which one or more aspects of various embodiments described herein can be implemented.

### DETAILED DESCRIPTION

Various aspects of the technology described herein are generally directed towards testing program code in multiple process modes without developing separate test cases for each process mode. The program code may be compiled and built into a running software component in either kernel mode or user mode. Testing the running software component is also performed in kernel mode or user mode. In one exemplary implementation, source code for the test cases (i.e., unit tests) is developed once in a form that is agnostic to a particular process mode. A testing mechanism employs common kernel mode source code and/or common user mode source code in order to compile the source code for the test cases and build a kernel mode implementation and/or a user mode implementation to effectuate testing of the running software component in either the user mode or the kernel mode, respectively.

It should be understood that any of the examples herein are non-limiting. As such, the present invention is not limited to any particular embodiments, aspects, concepts, structures, functionalities or examples described herein. Rather, any of the embodiments, aspects, concepts, structures, functionalities or examples described herein are non-limiting, and the present invention may be used various ways that provide benefits and advantages in computing and testing in general.

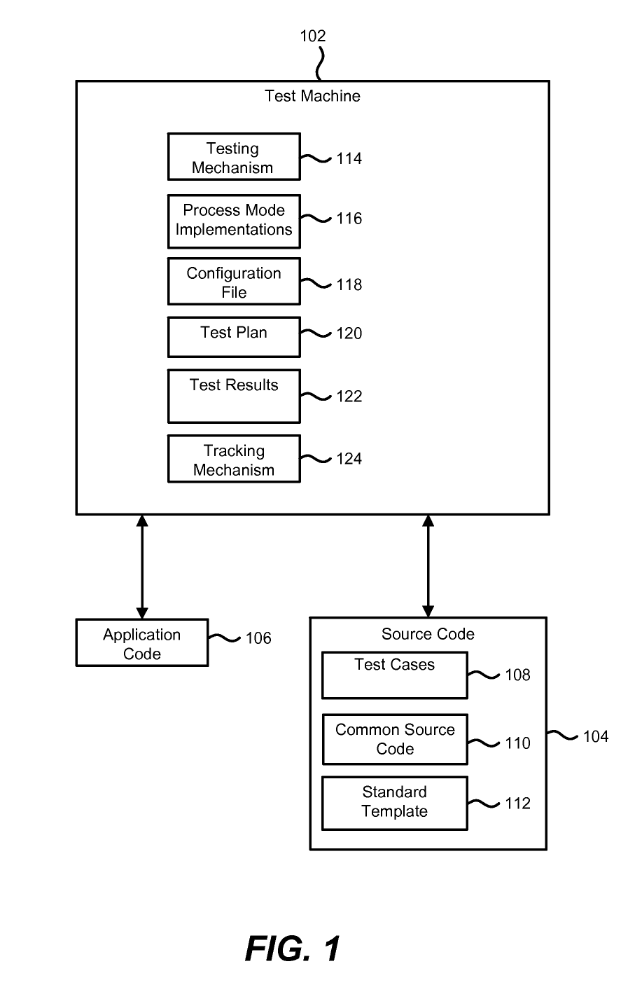

FIG. 1 is a block diagram illustrating an exemplary system for testing program code in multiple process modes according to one example implementation. In one exemplary implementation, the exemplary system includes a test machine 102, source code 104 and program code 106. As described herein, the program code 106 may be compiled and built into multiple process modes, such as a kernel mode and a user mode. The process modes may refer to hierarchical protection domains of computing security. Each protection domain affords a running computer program with a different set of privileges for utilizing various resources, such as a processor (CPU).

It is appreciated that the source code 104 includes files and/or code snippets including processor executable instructions in accordance with a programming language. In one exemplary implementation, the source code 104 implements one or more test cases 108 using common source code 110 and a standard template 112. Portions of the source code 104 may be compiled and built into multiple process modes. It is appreciated that the present disclosure is not limited to the user mode or the kernel mode and other process modes are envisioned by the description herein. For instance, the multiple process modes may also include a supervisor mode, an executive mode, a hypervisor mode for a virtual machine platform and/or the like.

In one exemplary implementation, the test machine 102 includes a testing mechanism 114 that uses the source code 104 to build process mode implementations 116 associated with the one or more test cases 108. Each of the test cases 108 refers to a function or method that verifies operability of one or more units (i.e., public methods and/or attributes) of a software component under development. Each test case declaration includes a unique name or identifier, a name of the method or function implementing the test case, any category to which the test case belongs and an input parameter description field. As an example, the method or function instantiates a specific class of the program code 106 and then, calls various class methods and/or examine various class attributes. The one or more test cases 108 may include a declaration for such a method or function according to the following example format:
static const KU_TEST_ENTRY gs_KuTestCases[ ]={{L“TestMethod1”, TestMethod1, L“TEST”, L“testmethod1”}, };”

According to one exemplary implementation, the source code 104 includes various files and/or code snippets to which the testing mechanism 114 compiles and builds into the process mode implementations 116. In one exemplary implementation, the source code 104 includes the common source code 110 (e.g., header files and/or source files) that, when compiled and linked to the testing mechanism 114, redirects function or IOCTL calls to the process mode implementations 116. The source code 104 also includes the standard template 112 in which the testing mechanism stores kernel mode and user mode implementations of the test cases 108.

It is appreciated that the source code 104 includes executable instructions in any programming language (e.g., C++) that is capable of being compiled into one or more process modes, such as a kernel mode or a user mode. In one exemplary implementation, the testing mechanism 114 generates the executable instructions for implementing the one or more test cases 108 using the standard template 112. The standard template 112 includes a programming interface that is used for both the kernel mode and the user mode of which an example format is as follows:
Typedef NTSTATUS (*KU_TEST_CASE) (int argc, WCHAR* args[ ]);

Accordingly, the process mode implementations 116 include binary files, assemblies and/or executable code that link to various portions of the source code 104. In one exemplary implementation, the process mode implementations 116 include a kernel mode implementation, such as a driver (e.g., .SYS driver) and a user mode implementation, such as a dynamic link library (e.g., .DLL file). In one exemplary implementation, the kernel mode implementation is a non-plug and play driver. The kernel mode implementation and the user mode implementation are compiled using the common source code 110 and the test cases 108.

In one exemplary implementation, a configuration file 118 (e.g., an Extensible Markup Language (XML) file) includes a specification for a creating a test plan 120. As an example, the configuration file 118 defines runtime input parameters for executing various combinations of the test cases in a form of a table. Each row of the table refers to a specific test comprising some of the test cases 108. Using different sets of input parameters, the specific test may execute a particular test case more than once. For each test case, the testing mechanism 114 parses a test case id and one or more input parameter values that are eventually passed to corresponding methods within the process mode implementations 116. An example format of the configuration file 118 is as follows:

```
<?xml version=“1.0” encoding=“utf-8”?>
<Data>
  <Table Id=“Test”>
    <ParameterTypes>
        <ParameterType Name=“Parameters”
        Array=“true”>String</ParameterType>
    </ParameterTypes>
    <Row Name=“Test”>
        <Parameter Name=“Parameters”>
            <Value>firstestcaseid:firstargument,secondargument
            </Value>
            <Value>secondtestcaseid:firstsecondargument</Value>
        </Parameter>
    </Row>
  </Table>
</Data>
```

As depicted in the example format, a data hive marks the beginning and end of the specification of test parameters. A table Id parameter represents a particular table comprising one or more tests. Each row specifies a set of test cases that will be executed as a unit and corresponds with a unique name. Each parameter value entry includes a test case identifier representing the particular test case to be executed with one or more subsequent input parameters. An example format is as follows:
[TestcaseId]:[InputParameter1],[InputParameter2],[InputParameter3], . . . [InputParameterN]

The following is an example of a parameter value entry for a test case to be run with three (3) input parameters:
<Value>TestcaseId:first,second,third/value>

The following is an example of a parameter value entry for a test case that is to be executed without input parameters:

<Value>TestId:</Value>

In one exemplary implementation, the testing mechanism 114 includes a dynamic link library (DLL) having an entry point for each test command type. As described herein, the test command type may include a List command, a RunTest command and a RunTests command. It is appreciated that the testing mechanism 114 may include entry points and functions for other test command types within a scope of the present disclosure.

The common source code 110 includes entry points for various functions that support execution of the test cases 108. For example, the common source code 110 may include executable instructions for a function that returned a number of the test cases 108 (i.e., QueryNumberOfTestCases), a function that lists the test cases 108 (i.e., QueryTestCases) and a function that executes the test cases 108 (i.e., RunTestCase). In one exemplary implementation, the common source code 110 includes a user mode version and a kernel mode version for each of these functions. Along with source code for the test cases 108, the kernel mode version and the user mode version are compiled and built into the kernel mode implementation and the user mode implementation as described herein. The testing mechanism 114 utilizes compiled builds of one or both of these implementations to execute a test command.

By way of example, in response to a List test command, the testing mechanism 114 calls the QueryTestCases function, which in turn accesses the test cases 108 and returns descriptive information of such test cases. In response to a RunTest test command specifying a particular test case and one or more input parameters, the testing mechanism 114 calls the RunTestCase function on one or more of the process mode implementations 116, which in turn accesses an exported function for executing the particular test case with the one or more input parameters.

The following pseudocode illustrates an exemplary implementation of an example RunTest command:

void RunTest(testCaseID, parameters_array)
{
If USER_MODE = TRUE, Call
UserModeImplementationDLL.RunTestCase (testCaseID,
parameters_array);
If KERNEL_MODE = TRUE, Call
KernelModeImplementationDriver.RunTestCase(testCaseID,
parameters_array);
}

In one exemplary implementation, the test plan 120 refers to a selection, via a test command, of certain tests to execute. The test command may form a portion of a command line in accordance with a standard syntax, such as PowerShell. The testing mechanism 114 applies a command line parser mechanism to identify each argument associated with the test command. After parsing the test command arguments, the testing mechanism 114 generates the test plan 120 based on these arguments and runs the certain tests as described herein.

In order to generate the test plan 120, the testing mechanism 114 examines a number of arguments within the test command. According to one exemplary implementation, an argument labeled “/p:C” represents a test command type, such “List”, “RunTest” and “RunTests”. The “List” command type delineates user mode test cases and/or kernel mode test cases within the process mode implementations 108. The “RunTest” command type instructs the testing mechanism 114 to perform one or more test cases as denoted by one or more test case identifiers. The “RunTests” command type causes the testing mechanism 114 to run a plurality of test cases associated with a particular test within the configuration file 118 or test cases within a particular category.

In another exemplary implementation, an argument labeled “/p:categories” determines which category or categories of test cases to run. If the argument “/p:c” is set to “RunTests”, then the “/p:categories” argument filters the tests defined in the configuration file 118 such that the testing mechanism 114 creates the test plan 120 having only test cases associated with the category or categories listed. In yet another exemplary implementation, an argument labeled “/p:ids” determines which specific test cases to run. If “/p:c” equals value “RunTest”, “/p:ids” indicates one or more test case identifiers for which the testing mechanism 114 filters the configuration file 102. Then, the testing mechanism 114 only executes test cases that correspond with these identifiers.

In another exemplary implementation, an argument labeled “/p:target=<value>” defines which of the process mode implementations 116 of test cases to utilize when executing the test plan 120. For example, if “/p:target=User” is identified, the testing mechanism 114 only runs user mode test cases. This argument is followed by another argument labeled “/p:dll”, which indicates the dynamic link library (DLL) comprising the user mode test cases. Similarly, if “/p:target=Kernel” is identified, the testing mechanism 114 only runs kernel mode test cases. This argument is followed by another argument labeled “/p:driver” that specifies a kernel mode driver comprising the kernel mode test cases. As another example, if argument “/p:target” is set to “Both”, the testing mechanism 114 executes tests using both kernel mode implementations and user mode implementations of one or more test cases.

According to one exemplary implementation, an argument labeled “/p:configfile=<value>” establishes the configuration file 118 from which the testing mechanism 114 identifies test definitions. For example, if a value for “/p:configfile” is “testinput.xml”, the testing mechanism 114 accesses this XML file when determining which test cases to include in the test plan 120 and later run during execution. As described by the following example configuration file “testinput.xml”, an exemplary test definition “Test” includes executing test case “SamplePass” twice with two input parameters and again with one input parameter and test case “SampleFail” once with no input parameters.

```
<?xml version=“1.0” encoding=“utf-8”?>
<Data>
  <Table Id=“Test”>
    <ParameterTypes>
        <ParameterType Name=“Parameters”
        Array=“true”>String</ParameterType>
    </ParameterTypes>
      <Row Name=“Test”>
        <Parameter Name=“Parameters”>
          <Value>SamplePass:firstInputParameter,
          secondInputParameter</Value>
          <Value>SamplePass:firstInputParameter</Value>
          <Value>SampleFail:</Value>
        </Parameter>
      </Row>
  </Table>
</Data>
```

After parsing an example test command that includes a “/p:C=RunTest” argument and a “/p:configfile=Table:TestInput.xml#Test” argument, the testing mechanism 114 runs each test case for “Test”. If the example test command further includes a “/p:ids=SamplePass” argument, the resulting test plan 120 only includes both “SamplePass” test cases. Hence, the testing mechanism 114 executes the “SamplePass” test case twice and does not execute the “SampleFail” test case according to one exemplary implementation.

In order to access test results 122 from the executing the test plan 120, the testing mechanism 114 may utilize a tracing mechanism 118 to which each test case of the process mode implementations 116 links according to one exemplary implementation. The source code 104 associated with the test cases 108 may link to various portions of a Kernel Mode Library and/or a User Mode Library. For example, the kernel mode implementation and the user mode implementation link to kernel callable functions and user callable functions, respectively, within a library that has been compiled for either mode.

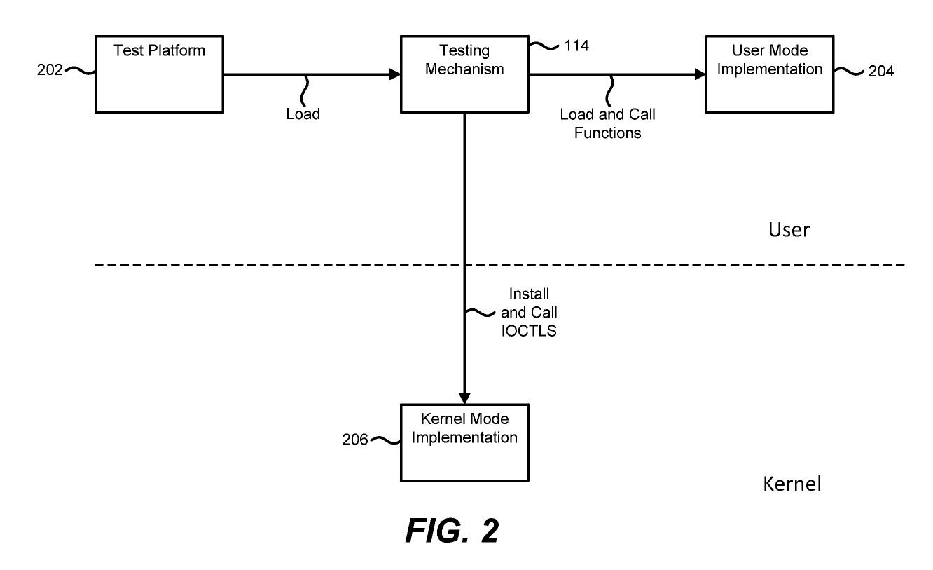

FIG. 2 is a block diagram illustrating components of an exemplary framework for unit testing program code according to one example implementation. In one exemplary implementation, a test platform 202 provides the exemplary framework for executing tests on the program code. The test platform 202 may include any known unit testing framework (e.g., Test Authoring and Execution Framework (TAEF)) or any proprietary framework that is compatible with the testing mechanism 114. It is appreciated that the testing mechanism 114 is, therefore, test platform independent.

As an example, the testing mechanism 114 comprises a dynamic link library (DLL) file that loads exported functions from a user mode implementation 204 and/or installs input and output controls (IOCTLs) interfaces from a kernel mode implementation 206. According to one exemplary implementation, the user mode implementation 204 and the kernel mode implementation 206 refer to a dynamic link library (DLL) file and a driver (SYS) file, respectively. Both of these files may include binaries that function as one or more test cases in either user mode or kernel mode. In order execute test cases in kernel mode, the driver file is a non-plug and play driver permitting the test platform 202 to dynamically install and remove the driver file according to one exemplary implementation.

In one exemplary implementation, the test platform 202 includes an executable file that loads the testing mechanism 114 and passes a configuration file and a test command to the testing mechanism 114. The testing mechanism 114 parses the test command into a number of arguments and executing one or more unit tests in accordance with such arguments. After determining the test command type, the testing mechanism 114 executes a corresponding function that calls exported functions and/or issues IOCTLS associated with one or more common entry points on the user mode implementation 204 and/or the kernel mode implementation 206. Based on the parsed arguments, the user mode implementation 204 and/or the kernel mode implementation 206 determines which tests cases are to be enumerated and/or executed and/or identifies corresponding test case implementation methods as described herein.

In one exemplary implementation, source code from which the user mode implementation 204 and the kernel mode implementation 206 are built includes common user mode source code and common kernel mode source code, respectively. Entry points within the common user mode source code and the common kernel mode source code refer to a common function interface. For example, such an interface includes a kernel mode version and a user mode version of a QueryNumofTestCases function, a QueryTestCases function and/or a RunTestCase function. The common kernel mode source code may define these functions as the following IOCTLS:
#define IOCTL_KU_CONTROL_QUERY_NUMBER_OF_TESTS CTL_CODE(KU_CONTROL_TYPE, 0x800, METHOD_BUFFERED, FILE_READ_ACCESS)
#define IOCTL_KU_CONTROL_QUERY_TESTS_CTL_CODE(KU_CONTROL_TYPE, 0x801, METHOD_BUFFERED, FILE_READ_ACCESS)
#define IOCTL_KU_CONTROL_START_TEST_CTL_CODE(KU_CONTROL_TYPE, 0x802, METHOD_BUFFERED, FILE_READ_ACCESS|FILE_WRITE_ACCESS)

In one exemplary implementation, the source code the user mode implementation 204 and the kernel mode implementation 206 are built also includes declarations for each of the test cases. Each test case declaration includes a unique name or identifier, a name of a method name implementing the test case, any category to which the test case belongs and an input parameter description field. The following illustrates an example set of declarations for three test cases having identifiers “SamplePass”, “SampleFail” and “SecondSampleFail”:

```
static const KU_TEST_ENTRY gs_KuTestCases[ ] =
{
  { L“SamplePass”, SamplePass, L“BVT,TEST”, L“samplepass”},
  { L“SampleFail”, SampleFail, L“FVT”, L“samplefail help”},
  { L“SampleSecondFail”, SampleSecondFail, L“BVT”,
  L“samplesecondfail help”}
};”
```

As described by the following example configuration file “testinput.xml”, an exemplary test definition “Test1” includes executing test case “SamplePass” twice and executing test case “SampleFail” twice and another exemplary test definition “Test2” includes executing test case “SampleFail” once and “SampleSecondFail” once.

```
<?xml version=“1.0” encoding=“utf-8”?>
<Data>
  <Table Id=“Test”>
    <ParameterTypes>
        <ParameterType Name=“Parameters”
        Array=“true”>String</ParameterType>
    </ParameterTypes>
      <Row Name=“Test1”>
        <Parameter Name=“Parameters”>
          <Value>SamplePass:firstInputParameter,
          secondInputParameter</Value>
          <Value>SamplePass:firstInputParameter</Value>
          <Value>SampleFail:</Value>
          <Value>SampleFail:firstInputParameter</Value>
        </Parameter>
      </Row>
      <Row Name=“Test2”>
        <Parameter Name=“Parameters”>
          <Value>SamplePass:</Value>
          <Value>SampleSecondFail:</Value>
        </Parameter>
      </Row>
    </Table>
</Data>
```

The following example test command labeled “List” includes arguments that, when parsed and executed, delineate both kernel mode and user mode test cases that correspond with a test labeled “Test1” within the configuration file 118 labeled “Testinput.xml”.
TestPlatform.exe TestingMechanism.dll/p:target=both/p:dll=UserModeImplementation/p:driver=KernelModeImplementation/p:c=List/p:configfile=Table:TestInput.xml#Test1

Accordingly, the testing mechanism 114 produces an output file listing two executions of test case “SamplePass” with two input parameters and one input parameter, respectively, and an execution of test case “SampleFail” with no input parameters and another execution with no input parameters.

The following example test command labeled “RunTest” includes arguments that, when parsed and executed, cause the testing mechanism 114 to separately run two iterations of both the kernel mode implementation 204 and the user mode implementation 206 versions of “SamplePass” using two input parameters for one iteration and one input parameter for another iteration and also omits both process mode implementations of “SecondSampleFail” because such a test case is not defined under “Test1”. In order to effectuate this test command, the testing mechanism 114 invokes two RunTestCase function calls for executing “SamplePass” on the user mode implementation 206 and, similarly, issues two RunTestCase IOCTL codes for executing “SamplePass” on the kernel mode implementation 204 as defined in “Test1” according to one exemplary implementation.
TestPlatform.exe TestingMechanism.dll/p:target=both/p:dll=UserModeImplementation/p:driver=KernelModeImplementation/p:c=RunTest/p:parameters=Table:TestInput.xml#Test1/p:ids=samplepass

After parsing arguments of the following example test command, the testing mechanism 114 executes the kernel mode implementation 206 of “SamplePass” twice, but does not execute “SampleFail” because such a function is not a member of a specified category, which in this example is the “BVT” category. Even though “SecondSampleFail” belongs to the category “BVT”, the testing mechanism 114 omits execution because “SecondSampleFail” is not defined under “Test1”.
TestPlatform.exe TestingMechanism.dll/p:target=kernel/p:driver=KernelModeImplementation/p:c=RunTests/p:categories=BVT/p:configfile=Table:TestInput.xml#Test1

The following example test command includes arguments that, when parsed and executed, cause the testing mechanism 114 to run the user mode implementation 204 of “SamplePass” and “SampleSecondFail” in which each is executed without any input parameters.
TestPlatform.exe TestingMechanism.dll/p:target=user/p:dll=UserModeImplementation/p:c=RunTests/p:configfile=Table:TestInput.xml#Test2

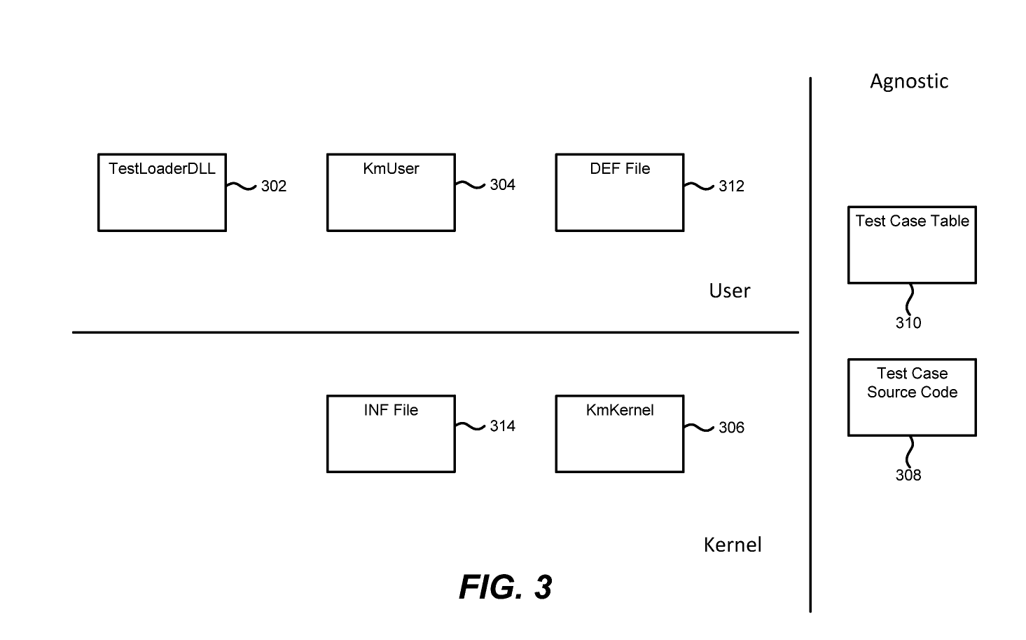

FIG. 3 is a block diagram illustrating exemplary source code for use in an exemplary framework for unit testing program code according to one example implementation. As described herein, the exemplary framework includes various example components, such as a TestLoaderDLL 302 as well as multiple process mode implementations associated with one or more test cases. These implementations may include assemblies or binaries that function as the test cases 108 in either user mode or kernel mode. The TestLoaderDLL 302 is an example testing mechanism 114.

The exemplary framework also includes common source code (e.g., the common source code 108 of FIG. 1) for building the multiple process mode implementations. In one exemplary implementation, the common source code includes common kernel mode source code, such as a KmUser 304 and common user mode source code, such as a KmKernel 306. For example, the KmUser 304 and the KmKernel 306 include environment variables, redirection function source code and/or references to shared libraries and/or header files that are specific to creating a user mode implementation and a kernel mode implementation, respectively, of the test cases.

In one exemplary implementation, test case source code 308 is generated using a standard template (e.g., a header file) and test case declarations within a test case table 310. For example, the standard template (e.g., the standard template 112 of FIG. 1) defines a test method skeleton for the test case declarations to which the TestLoaderDLL 302 automatically generates the test case source code 308. Subsequently, the TestLoaderDLL 302 compiles and builds the KmUser 304 and the test case source code 308 into the user mode implementation. Similarly, the TestLoaderDLL 302 compiles and builds the KmKernel 306 and the test case source code 308 into the kernel mode implementation.

In one exemplary implementation, the TestLoaderDLL 302 uses a code generation tool to build a .DLL file using the Km User 304 and the test case source code 308 as well as build a module definition (.DEF) file 312 for storing statements that describes attributes of the .DLL file, such as LIBRARY and EXPORT. Accordingly, the DLL file represents an example of the user mode implementation. The TestLoaderDLL 302 creates an import library (.LIB) from the .DEF file 312 to which the .DLL file links when being built. The following illustrates an example .DEF file 312:
;UserModeImplementation.DEF:
LIBRARY “UserModeImplementation”
EXPORTS
QueryNumberOfTests PRIVATE
QueryTests PRIVATE
RunTest PRIVATE

In another exemplary implementation, the TestLoaderDLL 302 uses the code generation tool to build a .SYS file using the KmKernel 304 and the test case source code 308 as well as build a driver installation (INF) file 314. Hence, the .SYS file is an example of the kernel mode implementation. The TestLoaderDLL 302 also uses the .INF file 310 to identify entry points within the .SYS file. An example of the .INF file 310 is as follows:
[Version]
Signature=“$WINDOWS NT$”
[KernelModeImplementation.NT.Wdf]
KmdfService=KernelModeImplementation, Km Unit_Service_kmdfInst
[Km Unit_Service_kmdfInst]
KmdfLibraryVersion=1.9

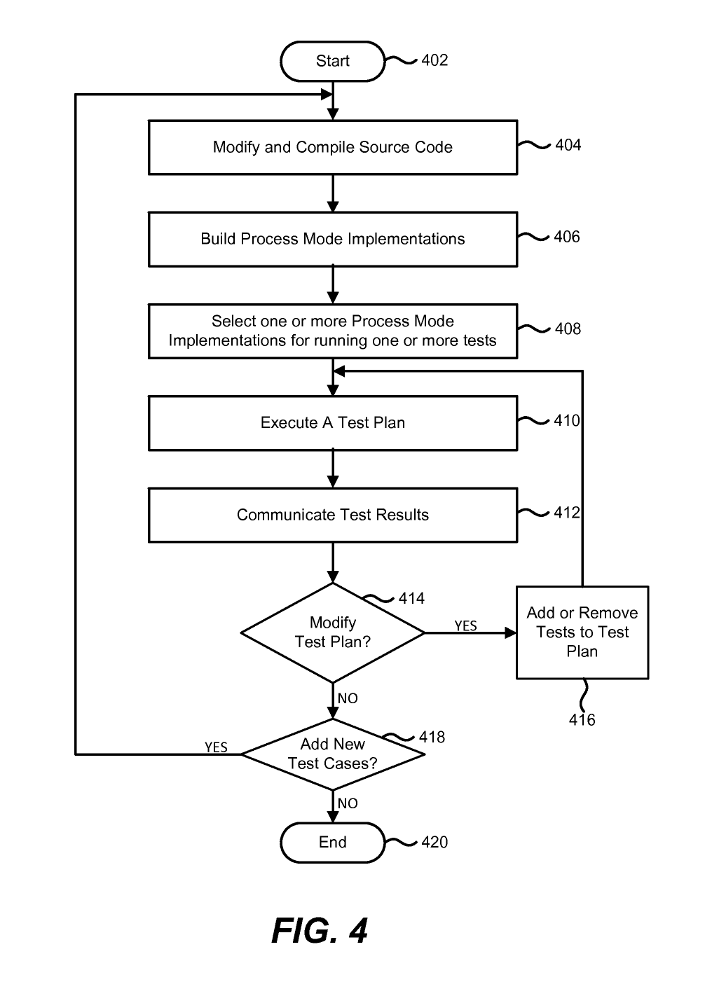

FIG. 4 is a flow diagram illustrating exemplary steps for testing program code in multiple process modes according to one example implementation. These steps describe a method that commence at step 402 and proceeds to step 404 at which the testing mechanism 114 (FIG. 1) modifies and compiles various source code including test case source code. It is appreciated that test case source code may implement one test case or a plurality of test cases based on a standard template as described herein. In order to generate the test case source code, the testing mechanism 114 stores each test case implementation into corresponding entry points of the standard template, which is subsequently compiled using a known compiler according to one exemplary implementation.

Step 406 is directed to building process mode implementations from the modified source code. For example, the testing mechanism 114 sets a KTL_USER _MODE variable to zero (0) in test case source code, which causes common kernel mode source code to be compiled with test case source code when building a kernel mode implementation of test cases. Similarly, the testing mechanism 114 sets a KTL_USER_MODE variable to one (1) in another copy of the test case source code, which causes a user mode implementation to be build using common user mode source code as well as the test case source code. Hence, the kernel mode implementation (e.g., a .SYS driver) and the user mode implementation (e.g., a DLL file) include a same set of functions but with different settings, libraries, header files and/or environment variables. When built, an entry point for a method within the kernel mode implementation corresponds with an entry point for the same method within the user mode implementation according to one exemplary implementation.

Step 408 represents selecting one or more process mode implementations to run one or more tests on the program code. As described herein, after building the user mode implementation and/or the kernel mode implementation from test case source code and the common source code, the testing mechanism 114 loads one or both of these implementations in accordance with a test command. A particular argument within the test command indicates which configuration file to use for test definitions according to one exemplary implementation.

Step 410 refers to executing a test plan based on the configuration file and/or any additional arguments within the test command. In one exemplary implementation, one or more arguments filter specific tests within the configuration file. For example, the testing mechanism 114 may select tests that match certain test case identifiers or categories. Step 412 refers to communicating test results to a software mode or output to a screen or text file.

Step 414 is directed to a determination as to whether to modify the test plan.

If the test plan is modified, the method described in FIG. 4 proceeds to step 416 where one or more tests are added to and/or removed from the test plan and then, returns to step 410. For example, the testing mechanism 114 adds calls to known test methods that belong to a particular category. If the test plan is not modified, the method described in FIG. 4 proceeds to step 418. Step 418 is directed to a determination as to whether to add new test cases. If new test cases are added, the method described in FIG. 4 returns to step 404 where the testing mechanism 114 modifies the test case source code to include source code for the new test cases. If no new test cases are added, the method described in FIG. 4 proceeds to step 420. Step 420 is directed to terminating the method described in FIG. 4.

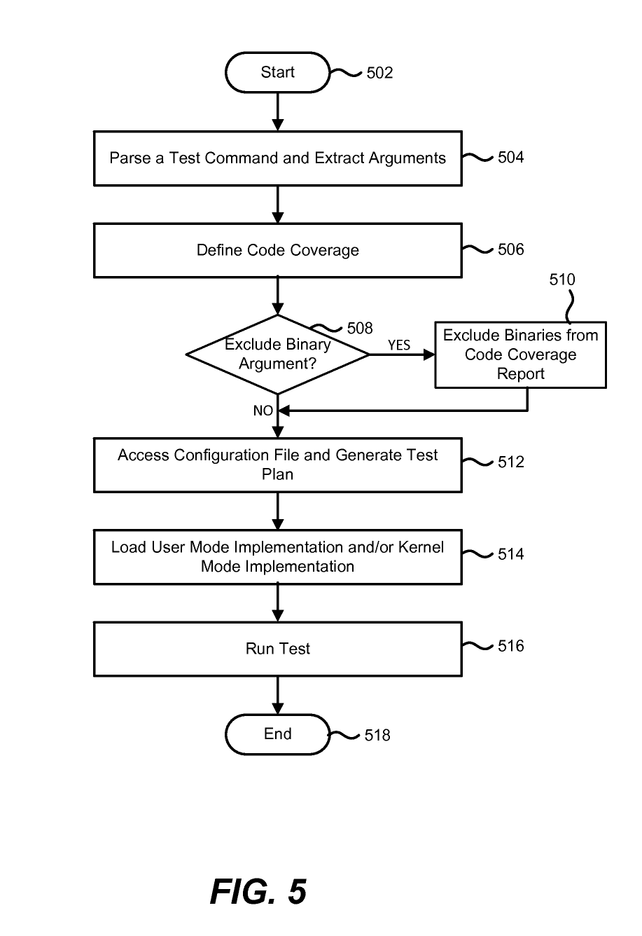

FIG. 5 is a flow diagram illustrating exemplary steps for selecting one or more process mode implementations of one or more test cases according to one example implementation. These steps describe a method that commence at step 502 and proceeds to step 504 at which the testing mechanism 114 parses a test command and extracts one or more arguments for performing unit tests on program code.

Step 506 refers to defining code coverage for executing the test command. As an example, the test command may indicate a type of code coverage report, such as local code coverage. For example, the test command may include specific binaries to load. Furthermore, the test command may specific a certain level of detail. By default, the level of detail in the code coverage report is seventy percent according to one exemplary implementation.

Step 508 refers to a determination as to whether to the test command includes an exclude binary argument. If the test command includes the exclude binary argument, the method described in FIG. 5 proceeds to step 510. Step 510 refers to excluding one or more binaries from the code coverage report. If the test command does not include the exclude binary argument, the method described in FIG. 5 proceeds to step 512.

Step 512 is directed to accessing a configuration file and generating a test plan. In one exemplary implementation, the testing mechanism 114 uses the arguments within the test command to determine which tests cases to execute using one or more sets of input parameters. Then, the testing mechanism 114 creates the test plan that includes iterations of these test cases, which are performed as a single test. Step 514 representing loading a user mode implementation and/or a kernel mode implementation for these test cases. Step 516 is directed to running the test on one or more binaries representing the user mode implementation and/or the kernel mode implementation. Step 518 terminates the steps described in FIG. 5.

### Exemplary Networked And Distributed Environments

One of ordinary skill in the art can appreciate that the various embodiments and methods described herein can be implemented in connection with any computer or other client or server device, which can be deployed as part of a computer network or in a distributed computing environment, and can be connected to any kind of data store or stores. In this regard, the various embodiments described herein can be implemented in any computer system or environment having any number of memory or storage units, and any number of applications and processes occurring across any number of storage units. This includes, but is not limited to, an environment with server computers and client computers deployed in a network environment or a distributed computing environment, having remote or local storage.

Distributed computing provides sharing of computer resources and services by communicative exchange among computing devices and systems. These resources and services include the exchange of information, cache storage and disk storage for objects, such as files. These resources and services also include the sharing of processing power across multiple processing units for load balancing, expansion of resources, specialization of processing, and the like. Distributed computing takes advantage of network connectivity, allowing clients to leverage their collective power to benefit the entire enterprise. In this regard, a variety of devices may have applications, objects or resources that may participate in the resource management mechanisms as described for various embodiments of the subject disclosure.

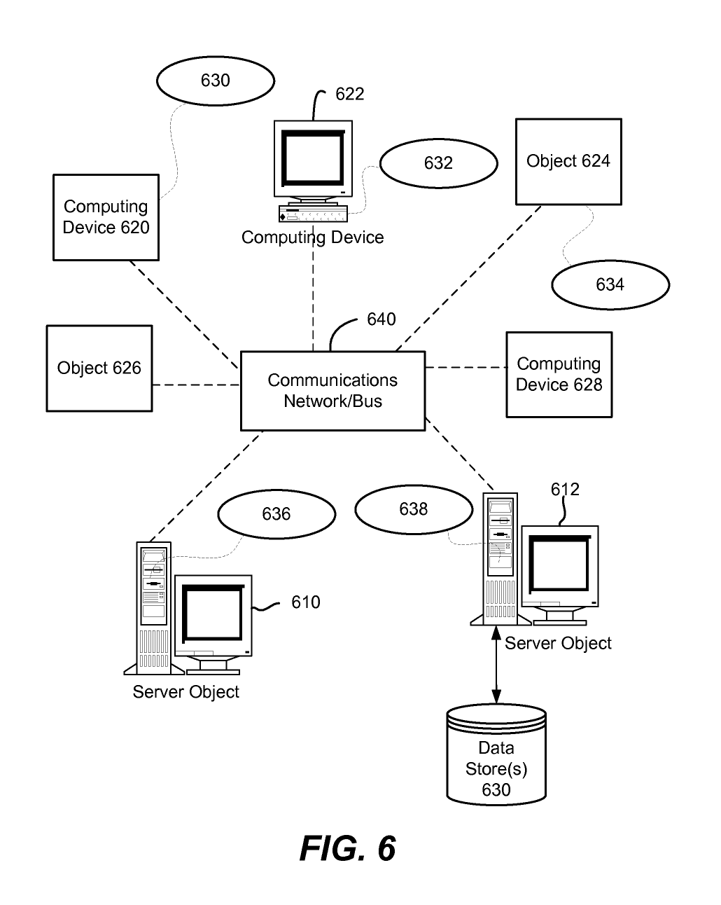

FIG. 6 provides a schematic diagram of an exemplary networked or distributed computing environment. The distributed computing environment comprises computing objects 610, 612, etc., and computing objects or devices 620, 622, 624, 626, 628, etc., which may include programs, methods, data stores, programmable logic, etc. as represented by example applications 630, 632, 634, 636, 638. It can be appreciated that computing objects 610, 612, etc. and computing objects or devices 620, 622, 624, 626, 628, etc. may comprise different devices, such as personal digital assistants (PDAs), audio/video devices, mobile phones, MP3 players, personal computers, laptops, etc.

Each computing object 610, 612, etc. and computing objects or devices 620, 622, 624, 626, 628, etc. can communicate with one or more other computing objects 610, 612, etc. and computing objects or devices 620, 622, 624, 626, 628, etc. by way of the communications network 640, either directly or indirectly. Even though illustrated as a single element in FIG. 6, communications network 640 may comprise other computing objects and computing devices that provide services to the system of FIG. 6, and/or may represent multiple interconnected networks, which are not shown. Each computing object 610, 612, etc. or computing object or device 620, 622, 624, 626, 628, etc. can also contain an application, such as applications 630, 632, 634, 636, 638, that might make use of an API, or other object, software, firmware and/or hardware, suitable for communication with or implementation of the application provided in accordance with various embodiments of the subject disclosure.

There are a variety of systems, components, and network configurations that support distributed computing environments. For example, computing systems can be connected together by wired or wireless systems, by local networks or widely distributed networks. Currently, many networks are coupled to the Internet, which provides an infrastructure for widely distributed computing and encompasses many different networks, though any network infrastructure can be used for exemplary communications made incident to the systems as described in various embodiments.

Thus, a host of network topologies and network infrastructures, such as client/server, peer-to-peer, or hybrid architectures, can be utilized. The “client” is a member of a class or group that uses the services of another class or group to which it is not related. A client can be a process, e.g., roughly a set of instructions or tasks, that requests a service provided by another program or process. The client process utilizes the requested service without having to “know” any working details about the other program or the service itself.

In a client/server architecture, particularly a networked system, a client is usually a computer that accesses shared network resources provided by another computer, e.g., a server. In the illustration of FIG. 6, as a non-limiting example, computing objects or devices 620, 622, 624, 626, 628, etc. can be thought of as clients and computing objects 610, 612, etc. can be thought of as servers where computing objects 610, 612, etc., acting as servers provide data services, such as receiving data from client computing objects or devices 620, 622, 624, 626, 628, etc., storing of data, processing of data, transmitting data to client computing objects or devices 620, 622, 624, 626, 628, etc., although any computer can be considered a client, a server, or both, depending on the circumstances.

A server is typically a remote computer system accessible over a remote or local network, such as the Internet or wireless network infrastructures. The client process may be active in a first computer system, and the server process may be active in a second computer system, communicating with one another over a communications medium, thus providing distributed functionality and allowing multiple clients to take advantage of the information-gathering capabilities of the server.

In a network environment in which the communications network 640 or bus is the Internet, for example, the computing objects 610, 612, etc. can be Web servers with which other computing objects or devices 620, 622, 624, 626, 628, etc. communicate via any of a number of known protocols, such as the hypertext transfer protocol (HTTP). Computing objects 610, 612, etc. acting as servers may also serve as clients, e.g., computing objects or devices 620, 622, 624, 626, 628, etc., as may be characteristic of a distributed computing environment.

### Exemplary Computing Device

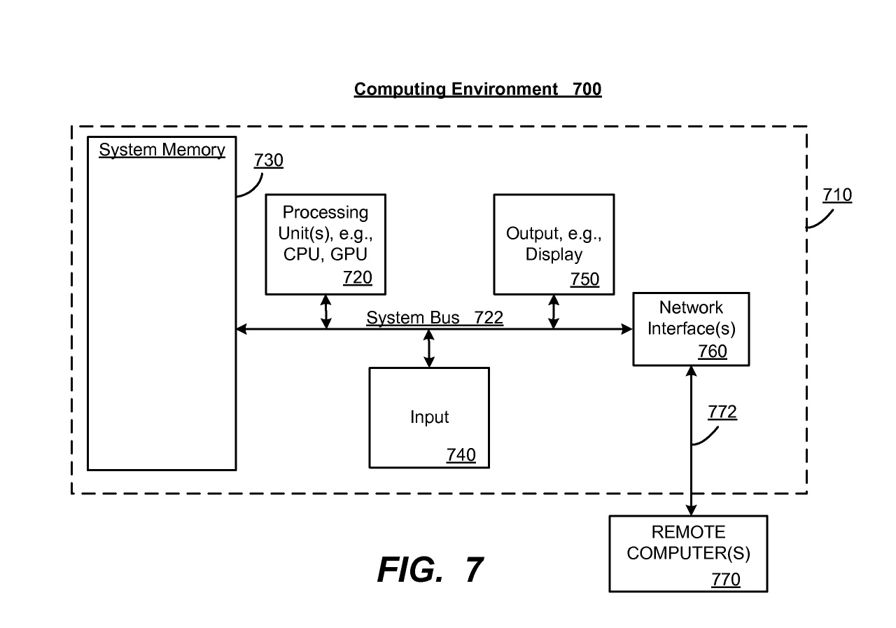

As mentioned, advantageously, the techniques described herein can be applied to any device. It can be understood, therefore, that handheld, portable and other computing devices and computing objects of all kinds are contemplated for use in connection with the various embodiments. Accordingly, the below general purpose remote computer described below in FIG. 7 is but one example of a computing device.

Embodiments can partly be implemented via an operating system, for use by a developer of services for a device or object, and/or included within application software that operates to perform one or more functional aspects of the various embodiments described herein. Software may be described in the general context of computer executable instructions, such as program modules, being executed by one or more computers, such as client workstations, servers or other devices. Those skilled in the art will appreciate that computer systems have a variety of configurations and protocols that can be used to communicate data, and thus, no particular configuration or protocol is considered limiting.

FIG. 7 thus illustrates an example of a suitable computing system environment 700 in which one or aspects of the embodiments described herein can be implemented, although as made clear above, the computing system environment 700 is only one example of a suitable computing environment and is not intended to suggest any limitation as to scope of use or functionality. In addition, the computing system environment 700 is not intended to be interpreted as having any dependency relating to any one or combination of components illustrated in the exemplary computing system environment 700.

With reference to FIG. 7, an exemplary remote device for implementing one or more embodiments includes a general purpose computing device in the form of a computer 710. Components of computer 710 may include, but are not limited to, a processing unit 720, a system memory 730, and a system bus 722 that couples various system components including the system memory to the processing unit 720.

Computer 710 typically includes a variety of computer readable media and can be any available media that can be accessed by computer 710. The system memory 730 may include computer storage media in the form of volatile and/or nonvolatile memory such as read only memory (ROM) and/or random access memory (RAM). By way of example, and not limitation, system memory 730 may also include an operating system, application programs, other program modules, and program data.

A user can enter commands and information into the computer 710 through input devices 740. A monitor or other type of display device is also connected to the system bus 722 via an interface, such as output interface 750. In addition to a monitor, computers can also include other peripheral output devices such as speakers and a printer, which may be connected through output interface 750.

The computer 710 may operate in a networked or distributed environment using logical connections to one or more other remote computers, such as remote computer 770. The remote computer 770 may be a personal computer, a server, a router, a network PC, a peer device or other common network node, or any other remote media consumption or transmission device, and may include any or all of the elements described above relative to the computer 710. The logical connections depicted in FIG. 7 include a network 772, such local area network (LAN) or a wide area network (WAN), but may also include other networks/buses. Such networking environments are commonplace in homes, offices, enterprise-wide computer networks, intranets and the Internet.

As mentioned above, while exemplary embodiments have been described in connection with various computing devices and network architectures, the underlying concepts may be applied to any network system and any computing device or system in which it is desirable to improve efficiency of resource usage.

Also, there are multiple ways to implement the same or similar functionality, e.g., an appropriate API, tool kit, driver code, operating system, control, standalone or downloadable software object, etc. which enables applications and services to take advantage of the techniques provided herein. Thus, embodiments herein are contemplated from the standpoint of an API (or other software object), as well as from a software or hardware object that implements one or more embodiments as described herein. Thus, various embodiments described herein can have aspects that are wholly in hardware, partly in hardware and partly in software, as well as in software.

The word “exemplary” is used herein to mean serving as an example, instance, or illustration. For the avoidance of doubt, the subject matter disclosed herein is not limited by such examples. In addition, any aspect or design described herein as “exemplary” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used, for the avoidance of doubt, such terms are intended to be inclusive in a manner similar to the term “comprising” as an open transition word without precluding any additional or other elements when employed in a claim.

As mentioned, the various techniques described herein may be implemented in connection with hardware or software or, where appropriate, with a combination of both. As used herein, the terms “component,” “module,” “system” and the like are likewise intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on computer and the computer can be a component. One or more components may reside within a process and/or thread of execution and a component may be localized on one computer and/or distributed between two or more computers.

The aforementioned systems have been described with respect to interaction between several components. It can be appreciated that such systems and components can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it can be noted that one or more components may be combined into a single component providing aggregate functionality or divided into several separate sub-components, and that any one or more middle layers, such as a management layer, may be provided to communicatively couple to such sub-components in order to provide integrated functionality. Any components described herein may also interact with one or more other components not specifically described herein but generally known by those of skill in the art.

In view of the exemplary systems described herein, methodologies that may be implemented in accordance with the described subject matter can also be appreciated with reference to the flowcharts of the various figures. While for purposes of simplicity of explanation, the methodologies are shown and described as a series of blocks, it is to be understood and appreciated that the various embodiments are not limited by the order of the blocks, as some blocks may occur in different orders and/or concurrently with other blocks from what is depicted and described herein. Where non-sequential, or branched, flow is illustrated via flowchart, it can be appreciated that various other branches, flow paths, and orders of the blocks, may be implemented which achieve the same or a similar result. Moreover, some illustrated blocks are optional in implementing the methodologies described hereinafter.

### Conclusion

While the invention is susceptible to various modifications and alternative constructions, certain illustrated embodiments thereof are shown in the drawings and have been described above in detail. It should be understood, however, that there is no intention to limit the invention to the specific forms disclosed, but on the contrary, the intention is to cover all modifications, alternative constructions, and equivalents falling within the spirit and scope of the invention.

In addition to the various embodiments described herein, it is to be understood that other similar embodiments can be used or modifications and additions can be made to the described embodiment(s) for performing the same or equivalent function of the corresponding embodiment(s) without deviating therefrom. Still further, multiple processing chips or multiple devices can share the performance of one or more functions described herein, and similarly, storage can be effected across a plurality of devices. Accordingly, the invention is not to be limited to any single embodiment, but rather is to be construed in breadth, spirit and scope in accordance with the appended claims.

What is claimed is:

1. In a computing environment, a method performed at least in part on at least one processor, comprising, testing program code in multiple process modes, including compiling source code for one or more tests cases, building process mode implementations associated with the one or more test cases using common source code for each process mode, and providing one or more of the process mode implementations for running the one or more test cases on the program code.

2. The method of claim 1, wherein providing the one or more of the process mode implementations further comprises executing a test plan using the one or more of the process mode implementations.

3. The method of claim 2, wherein providing the one or more of the process mode implementations further comprises parsing a test command specifying one or more tests for the test plan.

4. The method of claim 3 further comprising selecting the one or more of the process mode implementations based on the test command.

5. The method of claim 2 further comprising adding one or more tests to the test plan.

6. The method of claim 2 further comprising adding one or more new test cases to the process mode implementations.

7. The method of claim 2, further comprising defining code coverage for executing the test plan.

8. The method of claim 1, wherein the process mode implementations comprise a user mode implementation.

9. The method of claim 8, wherein building the process mode implementations further comprises building the user mode implementation using common user mode source code and the source code for the one or more tests cases.

10. The method of claim 1, wherein the process mode implementations comprise a kernel mode implementation.

11. The method of claim 10, wherein building the process mode implementations further comprises building the kernel mode implementation using common kernel mode source code and the source code for the one or more tests cases.

12. The method of claim 1, wherein compiling the source code for the one or more tests cases further comprises modifying the source code for the one or more tests cases to reference a tracing mechanism for generating test results.

13. The method of claim 1, wherein building the process mode implementations further comprises generating the source code for the one or more tests cases using a standard template.

14. In a computing environment, a system, comprising, a testing mechanism configured to run tests on program code, the testing mechanism configured to compile test case source code and common source code into a kernel mode implementation and a user mode implementation, parse a test command into one or more arguments, generate a test plan based on the one or more arguments and a configuration file, and execute the test plan using the kernel mode implementation or the user mode implementation.

15. The system of claim 14, wherein the testing mechanism communicates input/output control (IOCTL) codes to the kernel mode implementation according to the test plan.

16. The system of claim 14, wherein the testing mechanism communicates function calls to the user mode implementation according to the test plan.

17. The system of claim 14, wherein the testing mechanism returns test results associated with executing the test plan.

18. The system of claim 14, wherein the testing mechanism generates test case source code using a standard template.

19. One or more computer-readable media having computer-executable instructions, which when executed perform steps, comprising:
creating a standard template for one or more test cases;
generating test case source code using the standard template;
compiling source code for process mode implementations of the one or more test cases using common source code for each process mode;
filtering a configuration file using arguments of a test command to identify one or more tests to run; and
executing the one or more tests using one or more the process mode implementations.

20. The one or more computer-readable media of claim 18 having further computer-executable instructions comprising:
modifying the source code for the process mode implementations to reference a tracing mechanism for generating test results.
